(19) United States
(12) Patent Application Publication
(10) Pub. No.: US 2017/0169820 A1
(43) Pub. Date: Jun. 15, 2017

(54) ELECTRONIC DEVICE AND METHOD FOR CONTROLLING HEAD-MOUNTED DEVICE

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventor: Xiangjin CHEN, Tianjin (CN)

(21) Appl. No.: 15/247,569

(22) Filed: Aug. 25, 2016

Related U.S. Application Data
(63) Continuation of application No. PCT/CN2016/088884, filed on Jul. 6, 2016.

(30) Foreign Application Priority Data
Dec. 10, 2015 (CN) 201510926119.6

(51) Int. Cl. G10L 15/22; G09G 5/00; G10L 15/26; G10L 15/02; G10L 25/51; G10L 15/30

(52) U.S. Cl. CPC G10L 15/22; G10L 25/51; G10L 15/30; G10L 15/26; G10L 15/02; G09G 5/003; G10L 2015/223

(57) ABSTRACT

The present disclosure provides a method and apparatus for controlling a head-mounted device. The method includes the following steps: determining whether audio information acquired by an acquisition component on the head-mounted device is valid voice information or not; if yes, recognizing the valid voice information to obtain a recognition result; and executing a control operation indicated by the recognition result according to the recognition result.

### CROSS-REFERENCE TO RELATED APPLICATIONS

The application is a continuation of International Application No. PCT/CN2016/088884 filed on Jul. 6, 2016, which is based upon and claims priority to Chinese Patent Application No. 201510926119.6, entitled “METHOD AND APPARATUS FOR CONTROLLING HEAD-MOUNTED DEVICE”, filed Dec. 10, 2015, the entire contents of all of which are incorporated herein by reference.

### TECHNICAL FIELD

The present disclosure generally relates to the technical field of head-mounted devices, and in particular to a method and apparatus for controlling a head-mounted device.

### BACKGROUND

With the rapid development of science and technology, a variety of smart devices has entered into the lives of people. As a smart device, the head-mounted device becomes more and more popular among the masses of users, who can perform various manipulations more conveniently through the head-mounted device.

In the prior art, the head-mounted device is typically provided with a supporting remote controller, with which a user can control the head-mounted device or can be facilitated in use, and a few buttons can be disposed on the head-mounted device so that the user can control the head-mounted device through the buttons.

However, in the process of implementing the present disclosure, the inventor has found that, in the prior art, additional accessories require to be configured in the remote controller control manner as described above, which are inconvenient to carry by the user; and in the button control manner as described above, the physical buttons are typically implemented in a mechanical contact manner and thus are defective in terms of service life, moreover, since the head-mounted device requires to be worn on the head, the user needs to perform manipulation with intuition and a tactile sense to perceive the locations of the buttons, and thus, user experience is poor.

### SUMMARY

The present disclosure discloses a method and apparatus for controlling a head-mounted device to solve the problems of inconvenience in control and poor user experience in a conventional control technology for the head-mounted device.

An embodiment of the present disclosure discloses a method for controlling a head-mounted device, including the following steps:
determining whether audio information acquired by an acquisition component on the head-mounted device is valid voice information or not;
if yes, recognizing the valid voice information to obtain a recognition result; and
executing a control operation indicated by the recognition result according to the recognition result.

Correspondingly, an embodiment of the present disclosure discloses an electronic device, including at least one processor; and a memory communicably connected with the at least one processor for storing instructions executable by the at least one processor, wherein execution of the instructions by the at least one processor causes the at least one processor to:
determine whether audio information acquired by an acquisition component on an electronic device is valid voice information or not;
recognize the valid voice information to obtain a recognition result when the determination module has a positive determination result; and
execute a control operation indicated by the recognition result according to the recognition result.

An embodiment of the present disclosure discloses a computer program, including computer readable codes, wherein the operating of the computer readable codes on a head-mounted device leads to that the head-mounted device executes the method for controlling the head-mounted device above.

An embodiment of the present disclosure discloses a non-transitory computer readable medium storing executable instructions that, when executed by an electronic device, cause the electronic device to: determine whether audio information acquired by an acquisition component on the electronic device is valid voice information; recognize the valid voice information to obtain a recognition result when the determination module has a positive determination result; and execute a control operation indicated by the recognition result according to the recognition result.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart of the steps of a method for controlling a head-mounted device according to some embodiments of the present disclosure.

FIG. 2 is a flowchart of the steps of a method for controlling a head-mounted device according to some embodiments of the present disclosure.

FIG. 3 is a schematic diagram of a structure of a head-mounted device according to some embodiments of the present disclosure.

FIG. 4 is a block diagram of a structure of an apparatus for controlling a head-mounted device according to some embodiments of the present disclosure.

FIG. 5 is a block diagram of a structure of an apparatus for controlling a head-mounted device according to some embodiments of the present disclosure.

FIG. 6 shows schematically a block diagram of an electronic device for executing a method according to some embodiments of the present disclosure.

FIG. 7 shows schematically a storage unit for maintaining or carrying program codes for implementing a method according to some embodiments of the present disclosure.

### DETAILED DESCRIPTION

For the purpose of clarifying the objects, technical solutions and advantages of embodiments of the present disclosure, a clear and complete description will be made to technical solutions of the present disclosure in conjunction with corresponding drawings in the embodiment of the present disclosure. Obviously, the described embodiments are merely a part of the embodiments of the present disclosure and not all the embodiments. Based on the embodiments of the present disclosure, all other embodiments obtained by a person skilled in the art without paying creative work fall within the protection scope of the present disclosure.

### Embodiment 1

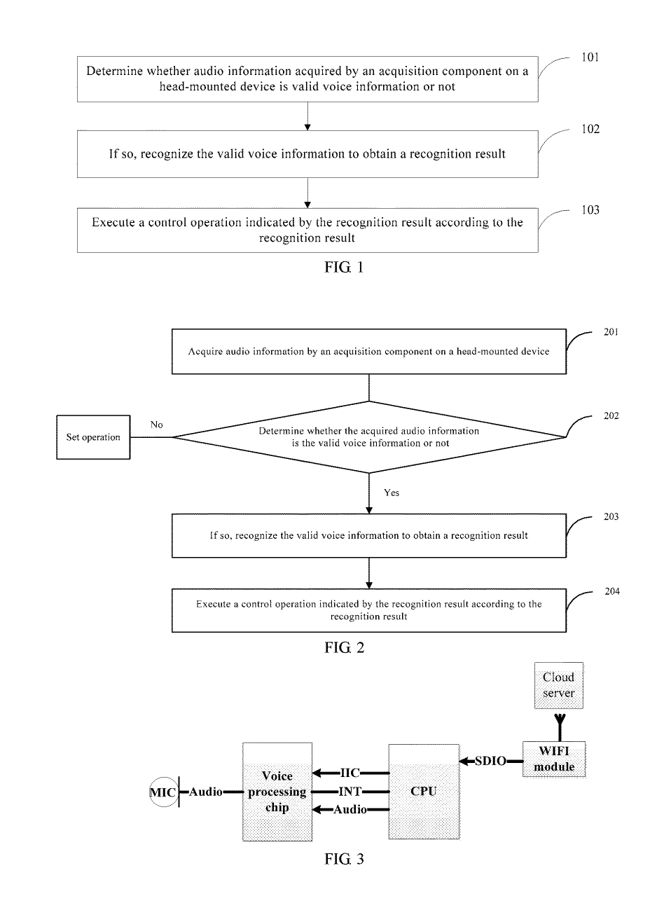

With reference to FIG. 1, it shows a flowchart of the steps of a method for controlling a head-mounted device of Embodiment 1 of the present disclosure.

The method for controlling the head-mounted device of the embodiment of the present disclosure may include the steps as follows.

Step 101, determine whether audio information acquired by an acquisition component on the head-mounted device is valid voice information or not.

In the embodiment of the present disclosure, the head-mounted device includes, but not limited to, a virtual helmet, a pair of virtual glasses, a riding helmet and the like. The head-mounted device is provided with an acquisition component, such as a microphone (MIC), in advance, and the acquisition component is used for acquiring outside audio information so that the head-mounted device can be controlled by voice.

To reduce power consumption, the head-mounted device does not respond to all the audio information, but only respond to the valid voice information, for example, for outside noise information or voice information not corresponding to the head-mounted device, the head-mounted device does not process the noise information or voice information as described above even though the acquisition component acquires the same, and the noise information or voice information as described above is invalid voice information. Therefore, in the embodiment of the present disclosure, after acquiring the audio information, the acquisition component determines whether the audio information is the valid voice information or not at first and then executes a corresponding operation according to a determination result.

Step 102, if yes, recognize the valid voice information to obtain a recognition result.

If the acquired audio information is determined to be the valid voice information in Step 101, the valid voice information is further recognized to obtain a recognition result, which is used for indicating a control operation to be performed on the head-mounted device; and the head-mounted device may respond to the recognition result and executes the control operation indicated by the recognition result, thereby achieving the purpose of controlling the head-mounted device with the voice.

Step 103, execute the control operation indicated by the recognition result according to the recognition result.

The embodiment of the present disclosure makes a simple description to the steps as described above, and the specific process of each step as described above will be discussed in details in Embodiment 2.

According to the method for controlling the head-mounted device provided by the embodiment of the present disclosure, the head-mounted device is provided with the acquisition component for acquiring the audio information; when acquiring the audio information, the acquisition component determines whether the audio information is the valid voice information or not, and if yes, recognizes the valid voice information to obtain a recognition result; and then, the head-mounted device may execute the control operation indicated by the recognition result. As can be seen, in the embodiment of the present disclosure, the head-mounted device can be controlled by voice so that the control can be performed without a button or a remote controller, thereby making the control of the head-mounted device more convenient and improving the user experience.

### Embodiment 2:

With reference to FIG. 2, it shows a flowchart of the steps of a method for controlling a head-mounted device of Embodiment 2 of the present disclosure.

The method for controlling the head-mounted device of the embodiment of the present disclosure may include the steps as follows.

Step 201, acquire audio information by an acquisition component on the head-mounted device.

With reference to FIG. 3, it shows a schematic diagram of a structure of a head-mounted device of Embodiment 2 of the present disclosure. The head-mounted device may include a MIC, a voice processing chip, a CPU (Central Processing Unit) and a WiFi (Wireless-Fidelity) module. Wherein the MIC is the acquisition component which is mainly used for acquiring the audio information (Audio) and sending the acquired audio information to the voice processing chip for processing; the voice processing chip is mainly used for performing voice wake-up, voice denoising and the like; and the CPU is mainly used for performing local voice recognition, local voice manipulation, transmission of voice information to a cloud and the like. A command, a state and the like may be exchanged between the voice processing chip and the CPU through an IIC (Inter Integrated Circuit), the CPU may also be controlled (such as waken up) through interruption (INT), and moreover, the Audio may also be sent to the CPU. An SDIO (Secure Digital Input and Output Card) interface is disposed between the CPU and the WiFi module, the CPU may send the audio information to a cloud server through the WiFi module, and the cloud server may perform voice recognition on the audio information.

In the embodiment of the present disclosure, to solve the problems of inconvenience in control and poor user experience of the head-mounted device, the acquisition component is used to acquire the audio information, and the head-mounted device is controlled through a series of processes including voice wake-up, voice recognition, and voice manipulation, which will be discussed in details in the following.

Step 202, determine whether the acquired audio information is the valid voice information or not. If yes, execute Step 203; and if not, execute a set operation.

This step corresponds to a voice wake-up process. A system of the head-mounted device is initially at a stand-by state, the MIC is in a low-power-consumption monitoring mode to monitor whether the audio information is present or not, and after the MIC acquires the audio information, the voice processing chip performs corresponding processing on the audio information to verify whether the audio information is the valid voice information or not.

Optionally, the Step 202 may include the substeps as follows.

Substep a1, perform signal waveform comparison on the acquired audio information and a plurality of preset standard audio information; execute Substep a2 if the standard audio information which is successfully matching the acquired audio information exists; and execute Substep a3 if the standard audio information which is successfully matching the acquired audio information does not exist.

In the embodiment of the present disclosure, a plurality of standard audio information corresponding to the head-mounted device can be set specific to the head-mounted device in advance, for example, corresponding audio information such as “Hello, LETV” can be set as the standard audio information specific to the head-mounted device from LETV. Where both the acquired audio information and the present standard audio information have an audio signal waveform, the acquired audio information and the standard audio information can be subjected to signal waveform comparison; the standard audio information is the valid voice information for the head-mounted device; therefore, if the acquired audio information and a certain audio information are matched successfully, the acquired audio information can be determined to be the valid voice information.

Optionally, the Substep a1 may include the follows.

a11, perform signal waveform comparison on a first segment of audio information from a beginning to a set time in the acquired audio information and the plurality of preset standard audio information; execute a12 if the standard audio information which is successfully matching the first segment of audio information does not exist; and execute a13 if the standard audio information which is successfully matching the first segment of audio information exists.

a12, if the standard audio information which is successfully matching the first segment of audio information does not exist, stop comparison and determine that the standard audio information which is successfully matching the acquired audio information does not exist.

The audio information acquired by the acquisition component may be noise information from an outside environment but not voice information, for example, when the head-mounted device is worn in a noisy environment, the acquisition component may acquire simple noise information. If the acquired audio information is the noise information, the comparison is unnecessary to perform on the whole segment of audio information when the acquired audio information and the standard audio information are compared, and the comparison is sufficient to perform just on a small segment of audio information, thereby reducing the complexity of a processing process. Therefore, during comparison, the signal waveform comparison is performed on the first segment of audio information from the beginning to the set time in the acquired audio information and the plurality of preset standard audio information at first; if the standard audio information which is successfully matching the first segment of audio information does not exist, the acquired audio information can be determined to be the noise information; therefore, the comparison is stopped, and the standard audio information which is successfully matching the acquired audio information is determined to be not present. Wherein the successful comparison means that both the acquired audio information and the standard audio information under comparison are the same in signal waveform. Regarding the specific value of the abovementioned set time, a person skilled in the art may perform relevant setting according to actual experience, for example, the set time may be set to be 10 ms, 30 ms and the like, and the embodiment of the present disclosure sets no limitation with respect thereto.

a13, if the standard audio information which is successfully matching the first segment of audio information exists, proceed to perform the signal waveform comparison on a second segment of audio information left in the acquired audio information except for the first segment of audio information and the successfully matched standard audio information; execute a14 if the standard audio information which is successfully matching the second segment of audio information does not exist; and execute a15 if the standard audio information which is successfully matching the second segment of audio information exists.

If the standard audio information which is successfully matching the first segment of audio information exists, it is possible to determine that the acquired audio information is not noise information, and in this situation, the signal waveform comparison is continuously performed on the second segment of audio information left in the acquired audio information except for the first segment of audio information and the successfully matched standard audio information (the successfully matched standard audio information here refers to the standard audio information which is successfully matching the first segment of audio information).

a14, if the standard audio information which is successfully matching the second segment of audio information does not exist, determine that the standard audio information which is successfully matching the acquired audio information does not exist.

If the standard audio information which is successfully matching the second segment of audio information does not exist, it indicates that the acquired audio information is not the valid voice information even though being the voice information, therefore, in this situation, it is still determined that the standard audio information which is successfully matching the acquired audio information does not exist.

a15, if the standard audio information which is successfully matching the second segment of audio information exists, determine that the standard audio information which is successfully matching the acquired audio information exists.

If the standard audio information which is successfully matching the second segment of audio information exists, the standard audio information undergoing successful comparison with the second segment of audio information is the standard audio information which is successfully matching the acquired audio information.

Substep a2, if the standard audio information which is successfully matching the acquired audio information exists, determine that the acquired audio information is the valid voice information.

Substep a3, if the standard audio information which is successfully matching the acquired audio information does not exist, determine that the acquired audio information is invalid voice information.

Step 203, if yes, recognize the valid voice information to obtain a recognition result.

This step corresponds to a voice recognition process. If the acquired audio information is the invalid voice information, such as the noise information and the audio information does not successfully match the standard audio information as described above, the voice processing chip makes no response, and the system proceeds to maintain a low power consumption state; and if the acquired audio information is the valid voice information, the voice processing chip wakes up the CPU, and the system enters a normal working state.

The voice processing chip sends the valid voice information to the CPU for recognition. Optionally, the voice processing chip may also perform denoising on the valid voice information at first and then send the desnoised valid voice information to the CPU. For example, noises and useful information in the valid voice information can be separated with technologies such as a blind source separation technology to facilitate the denoising. Regarding the issue of blind source separation, it is a process of restoring source signals only from mixed signals observed according to the statistical characteristics of the source signals in the event that the priori information of the source signals and transmission channels is not known; the blind source separation of the voice signal is a very important branch of the blind source separation technology, for example, the blind source separation can be performed by making use of algorithms such as independent component analysis (ICA for short); and for the specific process of the blind source separation, a person skilled in the art may perform relevant processing according to actual experience, and the embodiment of the present disclosure will not discuss it in details any more.

Optionally, in the embodiment of the present disclosure, the step of recognizing valid voice information to obtain a recognition result may include the substeps as follows.

Substep b1, recognizing the valid voice information locally; execute Substep b2 if a local recognition result can be obtained; and execute Substep b3 if a local recognition result is not obtained.

At first, the valid voice information is recognized in the local CPU, and this substep b1 may include the follows.

b11, convert the valid voice information into text information locally.

The CPU may convert the valid voice information into the text information by using a set software algorithm (such as iFLYTEK, LetvVoice etc.). For the specific process of conversion, a person skilled in the art may perform relevant processing according to actual experience, and the embodiment of the present disclosure will not discuss it in details any more.

b12, match the text information obtained through conversion with a plurality of preset standard text information; execute b13 if the standard text information matched with the text information obtained through conversion is present; and execute b14 if the standard text information matched with the text information obtained through conversion is not present.

In the embodiment of the present disclosure, a local command library is set in advance and may include a plurality of standard text information, such as startup, shutdown, volume-up, volume-down and the like, and the text information obtained after conversion is subjected to search matching with the local command library to determine whether the standard text information matched with the text information obtained through conversion is present or not. Wherein the matching may mean that the text information obtained through conversion is the same as the standard text information.

b13, if the standard text information matched with the text information obtained through conversion is present, take the matched standard text information as a local recognition result.

b14, if the standard text information matched with the text information obtained through conversion is not present, determine that no local recognition result is obtained.

Substep b2, if the local recognition result can be obtained, take the local recognition result as the recognition result.

Substep b3, if no local recognition result is obtained, send the valid voice information to a cloud server so that the cloud server recognizes the valid voice information to obtain a cloud recognition result, receive the cloud recognition result returned from the cloud server, and take the cloud recognition result as the recognition result.

If the local recognition result can be obtained, the local recognition result is taken as a final recognition result, upon which the head-mounted device is controlled. However, based on a local condition limitation (such as the limitation from storage space and the like), control commands corresponding to the head-mounted device may not possibly be saved to the local command library completely, for example, the valid voice information being “what is the weather like in Beijing now” and the like; in this situation, it is not to simply control the head-mounted device in terms of startup and shutdown and the like, but to necessarily perform information searching and other operations; therefore, there is also a situation in which the local recognition result is not obtained during local recognition, and in this situation, the CPU sends the valid voice information to the cloud server, by which the valid voice information is recognized to obtain a cloud recognition result. The cloud server performs semantic analysis on the valid voice information to obtain corresponding text information and executes a corresponding operation according to the text information; for example, where the valid voice information is the information related to audio/video resource searching, the cloud server performs audio/video resource searching to obtain an audio/video resource search result as a cloud recognition result; and for another example, where the valid voice information is the information related to map navigation information inquiring, the cloud server performs map inquiring to obtain a navigation information inquiring result as a cloud recognition result. After the cloud server obtains the cloud recognition result, the cloud recognition result is sent to the local head-mounted device, and the cloud recognition result is taken as the recognition result locally.

Step 204, execute the control operation indicated by the recognition results according to the recognition results.

This step corresponds to a voice manipulation process. After the recognition results are obtained locally, the head-mounted device automatically executes the control operations indicated by the recognition results according to the recognition results. Wherein, the recognition results include a local recognition result and a cloud recognition result. The local recognition result may be an instruction capable of simply controlling the head-mounted device, such as startup, shutdown, volume-up, volume-down and the like, and the head-mounted device responds to the local recognition result to execute the corresponding operation. The cloud recognition result can be some information, such as an audio/video resource search result, a navigation information inquiring result and the like, obtained through searching by the cloud server; after receiving the cloud recognition result, the head-mounted device may perform an interactive operation with a user, such as prompting the user on whether to display or play the cloud search result and the like; and after the user makes a confirmation, the head-mounted device receives a confirmation instruction to perform the operation such as displaying or playing the cloud search result.

In the present embodiment, the audio information is acquired through the microphone and transmitted to the voice processing chip for denoising (to increase a recognition rate) and waking up the CPU; after the denoising, the valid voice information is sent to the CPU for voice recognition locally or in the cloud server; and then the corresponding control operation is performed according to the recognition results, so that the head-mounted device is controlled without the button or remote controller, thereby making the control of the head-mounted device more convenient and improving the user experience.

For the sake of simplicity in description, the foregoing method embodiments are described as a series of act combinations, however, a person skilled in the art shall be informed that the present disclosure is not limited by the described ordering of acts, as some steps could, in accordance with the present disclosure, occur in other orders or concurrently. Further, a person skilled in the art shall also be informed that the embodiments as described in the description are embodiments in which the acts and modules involved are not necessarily required by the present disclosure.

### Embodiment 3

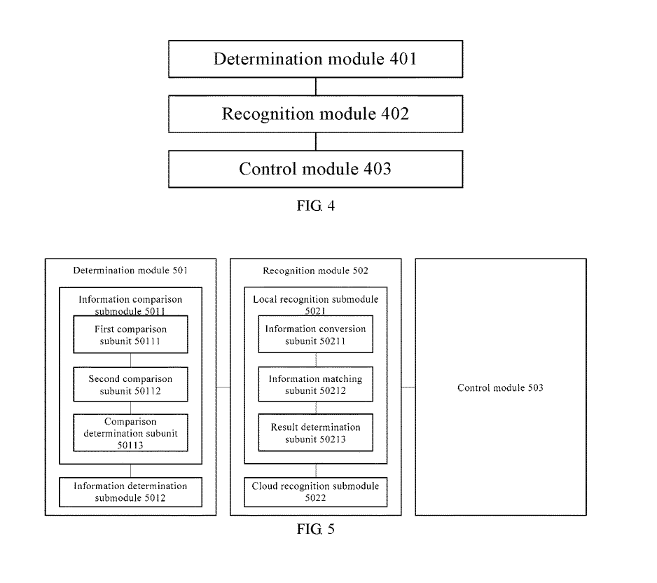

With reference to FIG. 4, it shows a block diagram of a structure of an apparatus for controlling a head-mounted device of Embodiment 3 of the present disclosure.

The apparatus for controlling the head-mounted device of the embodiment of the present disclosure may include the following modules:
a determination module 401 for determining whether audio information acquired by an acquisition component on the head-mounted device is valid voice information or not;
a recognition module 402 for recognizing the valid voice information to obtain a recognition result when the determination module has a positive determination result; and
a control module 403 for executing a control operation indicated by the recognition result according to the recognition result.

According to the apparatus for controlling the head-mounted device provided by the embodiment of the present disclosure, the head-mounted device is provided with an acquisition component for acquiring audio information; when acquiring the audio information, the acquisition component determines whether the audio information is the valid voice information or not, and if yes, recognizes the valid voice information to obtain the recognition result, and then, the head-mounted device may execute the control operation indicated by the recognition result. As can be seen, in the embodiment of the present disclosure, the head-mounted device can be controlled by voice so that the control can be performed without a button or a remote controller, thereby making the control of the head-mounted device more convenient and improving the user experience.

### Embodiment 4

With reference to FIG. 5, it shows a block diagram of a structure of an apparatus for controlling a head-mounted device of Embodiment 4 of the present disclosure;

The apparatus for controlling the head-mounted device of the embodiment of the present disclosure may include the following modules:
a determination module 501 for determining whether audio information acquired by an acquisition component on the head-mounted device is valid voice information or not;
a recognition module 502 for recognizing the valid voice information to obtain a recognition result when the determination module has a positive determination result; and
a control module 503 for executing a control operation indicated by the recognition result according to the recognition result.

Optionally, the determination module 501 includes: an information comparison submodule 5011 for performing signal waveform comparison on the acquired audio information and a plurality of preset standard audio information; and an information determination submodule 5012 for determining that the acquired audio information is the valid voice information when the standard audio information which is successfully matching the acquired audio information exists; and determining that the acquired audio information is invalid voice information when the standard audio information which is successfully matching the acquired audio information does not exist.

Optionally, the information comparison submodule 5011 includes: a first comparison subunit 50111 for performing signal waveform comparison on a first segment of audio information from a beginning to a set time in the acquired audio information and a plurality of preset standard audio information; a second comparison subunit 50112 for proceeding to perform the signal waveform comparison on a second segment of audio information left in the acquired audio information except for the first segment of audio information and the successfully matched standard audio information when the standard audio information which is successfully matching the first segment of audio information exists; and a comparison determination subunit 50113 for stopping comparison when the standard audio information which is successfully matching the first segment of audio information does not exist, determining that the standard audio information which is successfully matching the acquired audio information does not exist, determining the standard audio information which is successfully matching the acquired audio information does not exist when the standard audio information which is successfully matching the second segment of audio information does not exist, and determining that the standard audio information which is successfully matching the acquired audio information exists when the standard audio information which is successfully matching the second segment of audio information exists.

Optionally, the recognition module 502 includes: a local recognition submodule 5021 for recognizing the valid voice information locally, and taking a local recognition result as a recognition result if the local recognition result can be obtained; and a cloud recognition submodule 5022 for sending the valid voice information to a cloud server when the local recognition submodule does not obtain the local recognition result so that the cloud server recognizes the valid voice information to obtain a cloud recognition result, receiving the cloud recognition result returned from the cloud server, and taking the cloud recognition result as the recognition result.

Optionally, the local recognition submodule 5021 includes: an information conversion subunit 50211 for converting the valid voice information into text information locally; an information matching subunit 50212 for matching the text information obtained through conversion with a plurality of preset standard text information; and a result determination subunit 50213 for taking the matched standard text information as the local recognition result when the standard text information matched with the text information obtained through conversion is present, and determining that no local recognition result is obtained when the standard text information matched with the text information obtained through conversion is not present.

In the present embodiment, the audio information is acquired through a microphone and transmitted to a voice processing chip for denoising (to increase a recognition rate) and waking up a CPU; after the denoising, the valid voice information is sent to the CPU for voice recognition locally or in the cloud server; and then the corresponding control operation is performed according to the recognition result, so that the head-mounted device is controlled without the button or remote controller, thereby making the control of the head-mounted device more convenient and improving the user experience.

Apparatus embodiments are essentially similar to method embodiments and thus are described in a simpler way, and refer to part of the illustration of the method embodiments for points involved.

The apparatus embodiments described above are illustrative only, wherein the unit described as a separate part may be or may be not physically separated, a part displayed as the unit may be or may be not a physical unit, may be located in one place, or may be distributed on a plurality of network units. Some or all of the modules may be selected to achieve the objective of the solutions of the embodiments according to actual requirements. A person skilled in the art may understand and implement it without undertaking creative work.

Based on the description of the implementation modes above, a person skilled in the art may clearly understand that the implementation modes may be realized by virtue of software and a necessary general-purpose hardware platform, and certainly, by hardware as well. Based on such an understanding, the essential part of the abovementioned technical solutions or the contribution made by the abovementioned technical solutions to the prior art may take the form of a software product, and the computer software product may be stored in a computer-readable storage medium, such as a ROM/RAM, a magnetic disc, an optical disc, and includes a plurality of instructions allowing a computer device (which may be a personal computer, a server, or a network device and the like) to execute each embodiment or the method as described in some part of the embodiments.

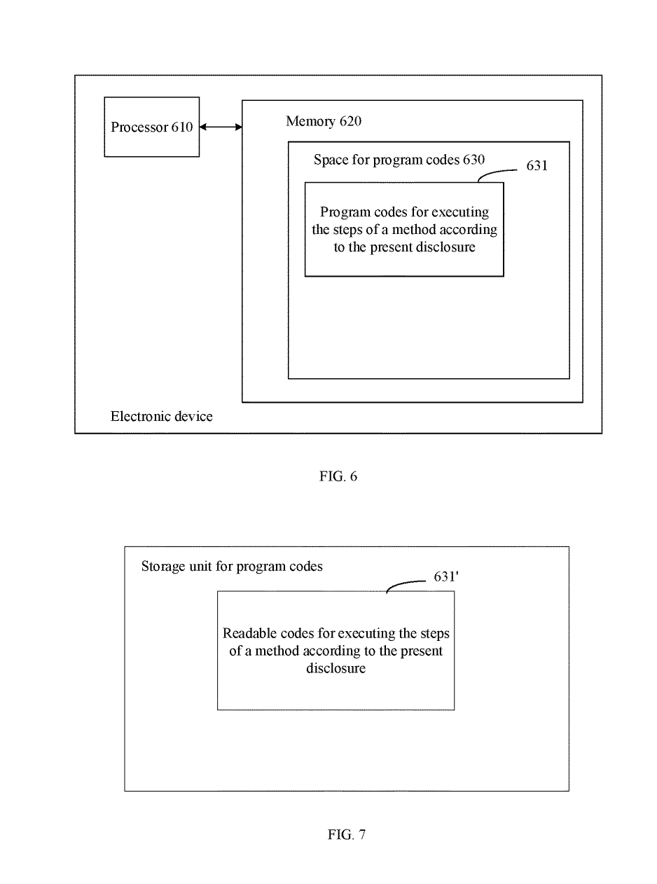

For example, FIG. 6 illustrates a block diagram of an electronic device for executing the method according the disclosure. The electronic device may be the head mounted device above. Traditionally, the electronic device includes a processor 610 and a computer program product or a computer readable medium in form of a memory 620. The memory 620 could be electronic memories such as flash memory, EEPROM (Electrically Erasable Programmable Read—Only Memory), EPROM, hard disk or ROM. The memory 620 has a memory space 630 for executing program codes 631 of any steps in the above methods. For example, the memory space 630 for program codes may include respective program codes 631 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 7. The memory cells may be provided with memory sections, memory spaces, etc., similar to the memory 620 of the electronic device as shown in FIG. 6. The program codes may be compressed for example in an appropriate form. Usually, the memory cell includes computer readable codes 631′ which can be read for example by processors 610. When these codes are operated on the electronic device, the electronic device may execute respective steps in the method as described above.

Finally, it should be noted that the foregoing embodiments are merely illustrative of technical solutions of the present disclosure without limitation; although the present disclosure is illustrated in detail with reference to the above embodiments, a person skilled in the art will appreciate that modifications may be made on the technical solutions cited by the above embodiments, or equivalent substitutions may be made on partial technical features; moreover, these modifications or substitutions will not make the essential of corresponding technical solutions depart from the spirit and scope of the technical solutions in respective embodiments of the present disclosure.

What is claimed:

1. A method for controlling a head-mounted device, comprising:
determining whether audio information acquired by an acquisition component on the head-mounted device is valid voice information or not;
if yes, recognizing the valid voice information to obtain a recognition result; and
executing a control operation indicated by the recognition result according to the recognition result.

2. The method according to claim 1, wherein the step of determining whether audio information acquired by an acquisition component on the head-mounted device is valid voice information comprises:
performing signal waveform comparison on the acquired audio information and a plurality of preset standard audio information;
if the standard audio information which is successfully matching the acquired audio information exists, determining that the acquired audio information is the valid voice information; and
if the standard audio information which is successfully matching the acquired audio information does not exist, determining that the acquired audio information is invalid voice information.

3. The method according to claim 2, wherein the step of performing signal waveform comparison on the acquired audio information and a plurality of preset standard audio information comprises:
performing signal waveform comparison on a first segment of audio information from a beginning to a set time in the acquired audio information and the plurality of preset standard audio information;
if the standard audio information which is successfully matching the first segment of audio information does not exist, stopping comparison and determining that the standard audio information which is successfully matching the acquired audio information does not exist;
if the standard audio information which is successfully matching the first segment of audio information exists, proceeding to perform the signal waveform comparison on a second segment of audio information left in the acquired audio information except for the first segment of audio information and the successfully matched standard audio information;
if the standard audio information which is successfully matching the second segment of audio information does not exist, determining that the standard audio information which is successfully matching the acquired audio information does not exist; and
if the standard audio information which is successfully matching the second segment of audio information exists, determining that the standard audio information which is successfully matching the acquired audio information exists.

4. The method according to claim 1, wherein the step of recognizing the valid voice information to obtain a recognition result comprises:
recognizing the valid voice information locally;
if a local recognition result is capable to be obtained, taking the local recognition result as the recognition result; and
if no local recognition result is obtained, sending the valid voice information to a cloud server so that the cloud server recognizes the valid voice information to obtain a cloud recognition result, receiving the cloud recognition result returned from the cloud server, and taking the cloud recognition result as the recognition result.

5. The method according to claim 4, wherein the step of recognizing the valid voice information locally comprises:
converting the valid voice information into text information locally;
matching the text information obtained through conversion with a plurality of preset standard text information;
if the standard text information matched with the text information obtained through conversion is present, taking the matched standard text information as a local recognition result; and
if the standard text information matched with the text information obtained through conversion is not present, determining that no local recognition result is obtained.

6. An electronic device, comprising:
at least one processor; and
a memory communicably connected with the at least one processor for storing instructions executable by the at least one processor, wherein execution of the instructions by the at least one processor causes the at least one processor to:
determine whether audio information acquired by an acquisition component on the electronic device is valid voice information;
recognize the valid voice information to obtain a recognition result when the determination module has a positive determination result; and
execute a control operation indicated by the recognition result according to the recognition result.

7. The electronic device according to claim 6, wherein determine whether audio information acquired by an acquisition component on the electronic device is valid voice information comprises:
performing signal waveform comparison on the acquired audio information and a plurality of preset standard audio information; and
determining that the acquired audio information is the valid voice information when the standard audio information which is successfully matching the acquired audio information exists; and determining that the acquired audio information is invalid voice information when the standard audio information which is successfully matching the acquired audio information does not exist.

8. The electronic device according to claim 7, wherein performing signal waveform comparison on the acquired audio information and a plurality of preset standard audio information comprises:
performing signal waveform comparison on a first segment of audio information from a beginning to a set time in the acquired audio information and a plurality of preset standard audio information;
proceeding to perform the signal waveform comparison on a second segment of audio information left in the acquired audio information except for the first segment of audio information and the successfully matched standard audio information when the standard audio information which is successfully matching the first segment of audio information exists; and
stopping comparison when the standard audio information which is successfully matching the first segment of audio information does not exist and determining that the standard audio information which is successfully matching the acquired audio information does not exist; determining the standard audio information which is successfully matching the acquired audio information does not exist when the standard audio information which is successfully matching the second segment of audio information does not exist; and determining that the standard audio information which is successfully matching the acquired audio information exists when the standard audio information which is successfully matching the second segment of audio information exists.

9. The electronic device according to claim 6, wherein recognize the valid voice information to obtain a recognition result when the determination module has a positive determination result comprises:
recognizing the valid voice information locally; and take a local recognition result as the recognition result when the local recognition result is capable to be obtained; and
sending the valid voice information to a cloud server when the a local recognition result is not obtained so that the cloud server recognizes the valid voice information to obtain a cloud recognition result, receiving the cloud recognition result returned from the cloud server, and taking the cloud recognition result as the recognition result.

10. The electronic device according to claim 9, wherein recognize the valid voice information locally; and take a local recognition result as the recognition result when the local recognition result is obtained comprises:
converting the valid voice information into text information locally;
matching the text information obtained through conversion with a plurality of preset standard text information; and
taking matched standard text information as the local recognition result when the standard text information matched with the text information obtained through conversion is present; and determining that no local recognition result is obtained when the standard text information matched with the text information obtained through conversion is not present.

11. A non-transitory computer readable medium storing executable instructions that, when executed by an electronic device, cause the electronic device to:
determine whether audio information acquired by an acquisition component on an electronic device is valid voice information;
recognize the valid voice information to obtain a recognition result when the determination module has a positive determination result; and
execute a control operation indicated by the recognition result according to the recognition result.

12. The non-transitory computer readable medium according to claim 11, wherein determine whether audio information acquired by an acquisition component on the electronic device is valid voice information comprises:
performing signal waveform comparison on the acquired audio information and a plurality of preset standard audio information;
if the standard audio information which is successfully matching the acquired audio information exists, determining that the acquired audio information is the valid voice information; and
if the standard audio information which is successfully matching the acquired audio information does not exist, determining that the acquired audio information is invalid voice information.

13. The non-transitory computer readable medium according to claim 12, wherein performing signal waveform comparison on the acquired audio information and a plurality of preset standard audio information comprises:
performing signal waveform comparison on a first segment of audio information from a beginning to a set time in the acquired audio information and the plurality of preset standard audio information;
if the standard audio information which is successfully matching the first segment of audio information does not exist, stopping comparison and determining that the standard audio information which is successfully matching the acquired audio information does not exist;
if the standard audio information which is successfully matching the first segment of audio information exists, proceeding to perform the signal waveform comparison on a second segment of audio information left in the acquired audio information except for the first segment of audio information and the which is successfully matched standard audio information;
if the standard audio information which is successfully matching the second segment of audio information does not exist, determining that the standard audio information which is successfully matching the acquired audio information does not exist; and
if the standard audio information which is successfully matching the second segment of audio information exists, determining that the standard audio information which is successfully matching the acquired audio information exists.

14. The non-transitory computer readable medium according to claim 11, wherein the recognize the valid voice information to obtain a recognition result comprises:
recognizing the valid voice information locally;
if a local recognition result is capable to be obtained, taking the local recognition result as the recognition result; and
if no local recognition result is obtained, sending the valid voice information to a cloud server so that the cloud server recognizes the valid voice information to obtain a cloud recognition result, receiving the cloud recognition result returned from the cloud server, and taking the cloud recognition result as the recognition result.

15. The non-transitory computer readable medium according to claim 14, wherein recognize the valid voice information locally comprises:
converting the valid voice information into text information locally;
matching the text information obtained through conversion with a plurality of preset standard text information;
if the standard text information matched with the text information obtained through conversion is present, taking the matched standard text information as a local recognition result; and
if the standard text information matched with the text information obtained through conversion is not present, determining that no local recognition result is obtained.
